(19) United States
(12) Patent Application Publication
(10) Pub. No.: US 2017/0144614 A1
(43) Pub. Date: May 25, 2017

(54) VEHICLE REAR SURFACE PROTECTOR

(71) Applicant: Robert B. DePalma, Weston, FL (US)

(72) Inventor: Robert B. DePalma, Weston, FL (US)

(21) Appl. No.: 14/947,617

(22) Filed: Nov. 20, 2015

(51) Int. Cl. B60R 13/01

(52) U.S. Cl. CPC B60R 13/013

(57) ABSTRACT

A vehicle rear surface protector for placement in the trunk and over the bumper of a vehicle includes a trunk section sized to cover at least a portion of the interior surface of the trunk, an intermediate section is sized and shaped to extend out of the trunk, and a bumper section sized to cover at least a portion of the exterior surface of an adjacent bumper. The vehicle rear surface protector additionally includes a latch pass which allows a trunk cover to be selectively closed its typical manner even when the vehicle rear surface protector remains deployed on a vehicle, in place in the trunk and over the adjacent bumper. The vehicle rear surface protector may further include a transverse seam of reduced thickness, thereby providing a natural folding crease.

### BACKGROUND OF THE INVENTION

Field of the Invention

This invention relates generally to vehicle accessories and, more particularly, to a surface protecting member operative to simultaneously cover a rear internal surface and rear external surface of a vehicle.

Description of the Prior Art

While the primary purpose of conventional automobiles is often considered to be the transport of people rather than goods, it is understood that some level of dedicated storage space is still generally desirable. As such, many conventional automobiles include a trunk or luggage compartment (collectively referred to herein as “trunk”) to provide such dedicated storage space. Such trunks, which depending on the design of the automobile may define a closed compartment or open compartment, is in many cases located at the rear of the automobile, accessible right above a rear bumper through a hinged cover member (such as a door or lid).

In some circumstances, it may be desirable to cover the bottom surface of a truck or the surface of an adjacent rear bumper (or both). By covering these surfaces, one may be able to not only protect the covered surfaces from scratches and dents, but, if done while loading items in or unloading items from a trunk, also prevent dust, dirt, and other debris present on the covered surfaces from getting on the items (or the person loading/unloading).

While there exist bumper protecting devices suited to attach to and cover the exterior surface of a rear bumper and provide protection against impact from other vehicles, carts or other mobile objects, a problem which still exists is that existing bumper protecting devices are not able to provide coverage of both the rear bumper and the trunk without obstructing the normal operation of the cover member of the truck. Thus, there remains a need for a vehicle rear surface protector which can be simultaneously positioned over the surface of a trunk floor and the surface of an adjacent bumper. It would be helpful if such a vehicle rear surface protector allowed for normal latching and unlatching of a trunk cover member even when deployed in the trunk and on the bumper. It would be additionally desirable for such a vehicle rear surface protector to include a seam which improves its ability to fold at a selected location.

The Applicant's invention described herein provides for a vehicle rear surface protector adapted to be positioned over the surface of a trunk floor and the surface of an adjacent bumper. The primary aspects of Applicant's vehicle rear surface protector are a trunk section, a intermediate section, and a bumper section. When in operation, the vehicle rear surface protector enables the simultaneously shielding of both interior trunk surfaces and exterior bumper surfaces, whether the trunk cover member is open or closed. As a result, many of the limitations imposed by prior art structures are removed.

### SUMMARY OF THE INVENTION

A vehicle rear surface protector for placement in the trunk and over the bumper of a vehicle. The vehicle rear surface protector comprises a cover body having a trunk section sized to cover at least a portion of the interior surface of the trunk, an intermediate section is sized and shaped to extend out of the trunk, and a bumper section sized to cover at least a portion of the exterior surface of an adjacent bumper. In varying embodiments, the cover body may define a planar mat having one or a plurality of discrete layers of flexible material. The vehicle rear surface protector additionally includes a latch pass which allows a trunk cover member to be selectively closed its typical manner even when the vehicle rear surface protector remains deployed on a vehicle, in place in the trunk and over the adjacent bumper. In some embodiments, the vehicle rear surface protector further includes a transverse seam having a reduced thickness so as to allow the bumper section and a portion of the intermediate section to be more easily folded on top of the trunk section.

It is an object of this invention to provide a vehicle rear surface protector which can be simultaneously positioned over the surface of a trunk floor and the surface of an adjacent bumper.

It is another object of this invention to provide a vehicle rear surface protector which allows for normal latching and unlatching of a trunk cover member even when deployed in the trunk and on the bumper.

It is yet another object of this invention to provide a vehicle rear surface protector which includes a seam which improves its ability to fold at a selected location.

These and other objects will be apparent to one of skill in the art.

### BRIEF DESCRIPTION OF THE DRAWINGS

FIG. 1 is a top plan view of a vehicle rear surface protector built in accordance with the present invention.

FIG. 2 is a side elevational view of a vehicle rear surface protector built in accordance with the present invention.

FIG. 3 is a perspective view of a vehicle rear surface protector in place on an automobile in accordance with the present invention with the automobile trunk cover member open.

FIG. 4 is a perspective view of a vehicle rear surface protector in place on an automobile in accordance with the present invention with the automobile trunk cover member closed.

### DETAILED DESCRIPTION OF THE INVENTION

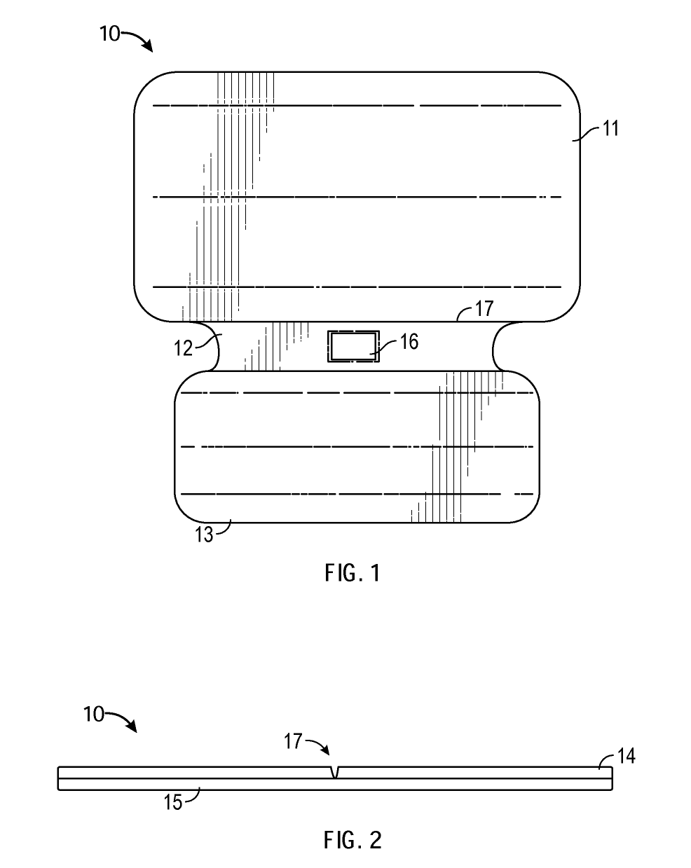

Referring now to the drawings and in particular FIGS. 1, 2, 3, and 4, a vehicle rear surface protector 10 is shown as a cover body which includes a trunk section 11, an intermediate section 12, and a bumper section 13. In the preferred embodiment, the cover body defines a substantially planar mat for use with a conventional vehicle 20, sized to cover at least a portion of a trunk 21 (or other luggage compartment) and a bumper 22 which is adjacent to the trunk 21. In one embodiment, the planar mat includes a top layer 14 constructed of a flexible fabric material and a lower layer 15 constructed of a deformable, non slip material having shock absorption and waterproof properties, such as rubber. In other embodiments, the planar mat may additionally include a base layer (not shown) which includes a plurality of non-scratch fibers or the planar mat may define a single or multiple layers.

In some embodiments, planar mat has distinct material defining the lower level 15 in at least one of the trunk section 11, intermediate section 12, and bumper section 13. For example, a fabric lower level 15 may be employed in the trunk section 11 while a rubber lower level 15 may be employed in the bumper section. Similarly, in embodiments where the planar mat defines a single layer the trunk section 11, intermediate section 12, and bumper section 13 may be constructed of distinct materials (i.e. fabric for the trunk section 11 and rubber for the bumper section 13.

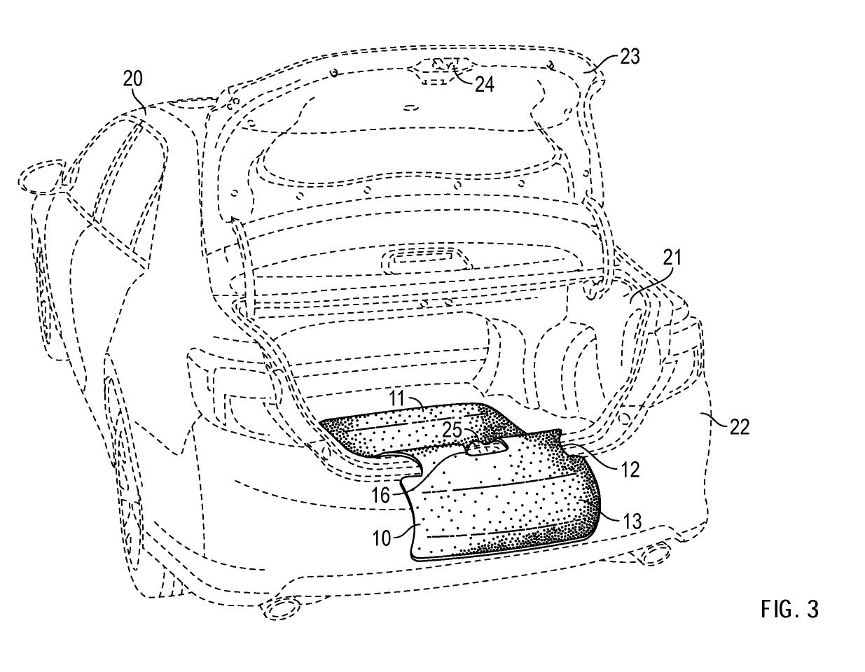

Through its flexible properties and the varying dimensions of its trunk section 11, intermediate section 12, and bumper section 13, the planar mat is adapted to simultaneously lie flat against an interior surface of a trunk 21, covering at least a portion thereof, extend out of the trunk 21, and lie against a bumper 22 that is adjacent to the trunk so as to cover a portion thereof (as illustrated in FIG. 3). Specifically, the trunk section 11 is sized to cover at least a portion of the interior surface of the trunk 21, the intermediate section 12 is sized and shaped to extend out of the interior of the trunk 21 between any opposing side walls which frame the trunk 21 opening, thereby allowing the planar mat to pass out of the trunk without riding up the such side walls, and the bumper section 13 is sized to cover at least a portion of the exterior surface of the bumper 22. In the preferred embodiment, the intermediate section 12 defines a more narrow section of the planar mat relative to the trunk section 11 and bumper section 13.

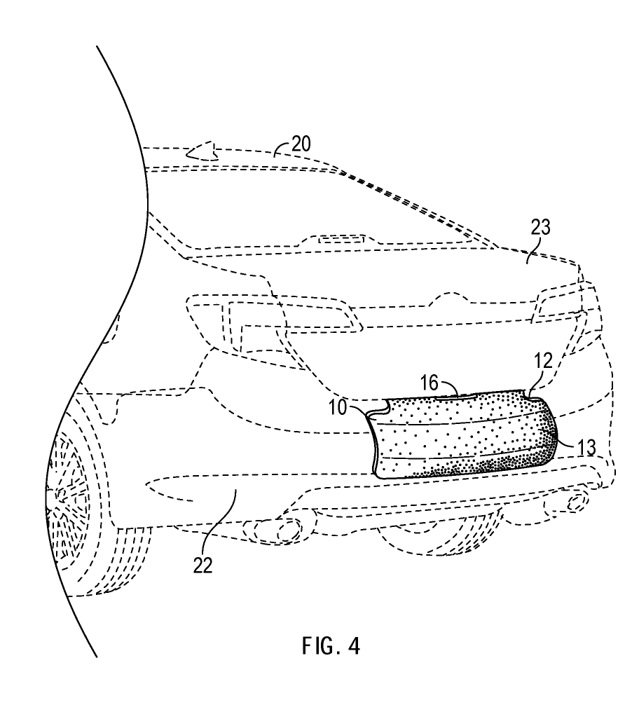

The intermediate section 12 additionally includes a latch pass 16 which defines an aperture in the planar mat. The latch pass 16 allows at least one of the opposing components of a trunk locking mechanism (generally a first locking portion 24 integral with a trunk cover member 23 and a second locking portion 25 integral with the vehicle 20 near the bumper 22) to pass through the planar mat so that they may selectively engage each other in the same manner they would if the vehicle rear surface protector 10 was not in place on the vehicle 20. In this regard, even when the vehicle rear surface protector 10 in place on a vehicle, positioned to protect the trunk 21 interior surface and the bumper 22 exterior surface, the trunk cover member 23 associated with the trunk 21 can be closed and locked in its normal manner (as illustrated in FIG. 4).

In one embodiment, the vehicle rear surface protector 10 includes a transverse seam 17 which defines a portion of the planar mat having a reduced thickness relative to the rest of the planar mat. It is contemplated that the transverse seam 17 makes it easier to fold the vehicle rear surface protector 10 substantially in half, allowing the bumper section 13 and a portion of the intermediate section 12 to be selectively folded into the trunk 21, on top of the trunk section 11. In addition, in embodiments where the interior surface of the trunk 21 is on a lower plane than the second locking portion 25, the transverse seam 17 allows the vehicle rear surface protector 10 to more easily transition from a horizontal orientation against the interior surface of the trunk 21 to an inclining surface as the vehicle rear surface protector 10 extends out of the trunk 21.

It is appreciated that the trunk section 11 may be sized such that it is larger than the intermediate section 12 and bumper section 13, thereby providing a counterweight operative to improve the ability for the vehicle rear surface protector 10 to remain in place on a vehicle 20. In some embodiments, however, the trunk section 11, intermediate section 12, and bumper section 13 may have alternative relative sizes (particularly if a natural counterweight is not required, such as if a fastener is used to hold the vehicle rear surface protector 10 in place).

It is contemplated that in various embodiments, the trunk section 11 may alternatively be sized and contoured to completely cover the interior surface of the trunk or the entire floor surface of the trunk.

It is contemplated that in an alternate embodiment, the cover body may include elevated portions operative to partition sections of a vehicle trunk.

In some embodiments, the bumper section 12 may include some desired written indicia, thereby enabling commercializing or promotional opportunities for vehicle rear surface protector 10.

The instant invention has been shown and described herein in what is considered to be the most practical and preferred embodiment. It is recognized, however, that departures may be made therefrom within the scope of the invention and that obvious modifications will occur to a person skilled in the art.

1. A vehicle rear surface protector for use with a vehicle, comprising a cover body defining a substantially planar mat having a continuous, flat bottom surface that is constructed of a non slip material, wherein said cover mat includes a trunk section configured to placed on at least a portion of an interior surface of a vehicle trunk, a bumper section configured to be placed on at least a portion of an exterior surface of a vehicle bumper that is adjacent to the vehicle trunk, and an intermediate section disposed between the trunk section and bumper section that is configured to extend from the interior of the vehicle trunk to the exterior surface of the vehicle bumper;
wherein said intermediate section has a reduced width relative to the trunk section and the bumper section;
wherein said cover body includes a transverse seam defining a portion of the planar mat having a reduced thickness, thereby providing a fixed joint about which the planar mat can be folded; and
wherein said cover body is adapted to allow a trunk cover member associated with the vehicle trunk to be fastened in place thereon while the cover body is in place on the respective surfaces of the vehicle trunk and vehicle bumper.

2. The vehicle rear surface protector of claim 1, wherein said cover body defines a unitary structure.

3.-5. (canceled)

6. The vehicle rear surface protector of claim 1, wherein said intermediate section includes a latch pass defining an aperture in said cover body, thereby adapting the cover body to allow a trunk cover member associated with the vehicle trunk to be fastened in place thereon while the cover body is in place on the respective surfaces of the vehicle trunk and vehicle bumper.

7.-8. (canceled)

9. The vehicle rear surface protector of claim 1, wherein said planar mat includes a plurality of discrete layers.

10. The vehicle rear surface protector of claim 1, wherein said planar mat includes at least one waterproof layer.

11. The vehicle rear surface protector of claim 1, wherein said bumper section includes written indicia thereon, thereby providing commercialization, personalization, or promotional space.

12.-14. (canceled)

15. The vehicle rear surface protector of claim 2, wherein said intermediate section includes a latch pass defining an aperture in said cover body, thereby adapting the cover body to allow a trunk cover member associated with the vehicle trunk to be fastened in place thereon while the cover body is in place on the respective surfaces of the vehicle trunk and vehicle bumper.

16.-20. (canceled)
